(19) United States
(12) Patent Application Publication
(10) Pub. No.: US 2014/0205529 A1
(43) Pub. Date: Jul. 24, 2014

(54) METHOD FOR STORING A GAS BY CHEMISORPTION ON A POROUS MATERIAL COMPRISING EXPANDED GRAPHITE

(71) Applicants: Francis Kindbeiter, Pia (FR); Laurent Rigaud, Pia (FR)

(72) Inventors: Francis Kindbeiter, Pia (FR); Laurent Rigaud, Pia (FR)

(73) Assignee: COLDWAY, Pia (FR)

(21) Appl. No.: 14/232,809

(22) PCT Filed: Aug. 2, 2012
(86) PCT No.: PCT/FR2012/051840

§ 371 Date: Apr. 3, 2014

(30) Foreign Application Priority Data
Aug. 12, 2011 (FR) 11/02514

(51) Int. Cl. C01C 1/00; F17C 11/00

(52) U.S. Cl. CPC C01C 1/006; F17C 11/00
USPC 423/352; 423/648.1; 564/463; 206/7

(57) ABSTRACT

Method for storing a gas in solid phase so that it can be distributed in gaseous phase, that consists in introducing the gas in gaseous phase into a storage tank (1) containing a reactive mixture the apparent density of which is between 40 kg/m3 and 60 kg/m3 and preferably of the order of 50 kg/m3, and which is made up of a reactive product and of expanded natural graphite, this reactive mixture and the gas being such that, when brought into the presence of one another, the reactive product and the gas undergo a thermochemical reaction the effect of which is that the gas is absorbed by the reactive product and a solid product of reaction is produced and, conversely, undergo a reverse thermochemical reaction in which the gas absorbed by the reactive product is desorbed when this product is heated after it has absorbed the gas.

The present invention relates to a method and a device for storing in solid phase a gas normally stored in liquid phase, for distribution in gaseous phase.

It is known that in order to store gases that are normally in gaseous phase under normal conditions of temperature and pressure, particularly for purposes of transport, the gases are compressed in order to change them into liquid phase; consequently, the quantity of gas stored in a same volume is considerably increased.

However, storage of these gases in liquid phase has various disadvantages.

A first disadvantage is the instability of the stored liquid phase, which requires the user to take precautions, particularly when it involves their transport.

A second disadvantage is related to the fact that, on the one hand, the volume of liquefied gas increases with the temperature, and on the other hand, the pressure in the storage tanks also rises and increases with the temperature; consequently, the tanks that contain them must integrate these various factors, thus requiring the designer to give them a thickness far greater than they would have if they only contained gas in gaseous phase.

Moreover, in another domain of the technology, there are cold production systems using thermochemical means in which a reactor is placed in controlled communication with a tank containing a gas in liquid phase. When the reactor and the tank are placed in communication, the liquid gas contained in the tank is vaporized, which absorbs a certain amount of heat, so the tank is cooled and said gas is absorbed by the reagent, thus generating an exothermic chemical reaction. Consequently, the reactor is the source of a release of heat. Once the reaction is ended, if the product contained in the reactor is reheated, the gas that was absorbed by the reagent is released and this gas is then condensed in the tank. Such devices are used in certain cold production systems, particularly when it is desired to have operational autonomy with regard to a source of electricity.

The present invention proposes to use the reactor of such a device as storage tank for a gas in order to store it therein in solid form. Indeed, it has been found that when all of the gas in gaseous phase has reacted with the reagent, the result is a reaction product that forms a solid compound.

For example, in the case of a reagent composed of manganese chloride and a gas composed of ammonia, said thermochemical reaction is as follows:

Mn(NH₃)₂Cl₂+4(NH₃) [symbol] Mn(NH₃)₆Cl₂+δH_{R}

and the solid reaction product thus obtained is an ammoniate of the manganese chloride.

A purpose of the present invention is to propose a method making it possible to store gases in solid phase that were initially in gaseous phase in order to enable their transport without the need for the user to take special precautions, while providing for the distribution of said gas in gaseous phase.

A purpose of the present invention is also a method of storing a gas in solid phase for distribution in gaseous phase, characterized in that it consists of introducing the gas in gaseous phase into a storage tank containing a reactive mixture, the apparent density of which is between 40 kg/m³ and 60 kg/m³ and preferably on the order of 50 kg/m³, and which is composed of a reagent and expanded natural graphite, said reactive mixture and the gas being such that, when brought into the presence of one another, the reagent and the gas undergo a thermochemical reaction, the effect of which is that the gas is absorbed by the reagent and a solid reaction product is produced and, conversely, they undergo a reverse thermochemical reaction in which the gas absorbed by the reagent is desorbed when this product is heated after it has absorbed the gas.

According to the invention, the reactive mixture will preferably be in the form of a block. Indeed, it is known that for all of the reagent to be able to react with the gas, it is essential that the gas be able to circulate easily and freely within the “mass” of the reagent. This is why it has been proposed in cold production techniques that use this same type of thermochemical reaction to use a matrix binder that makes it possible to increase the permeability of the reagent. Moreover, said matrix binder will have good thermal conductivity, which would allow it to evacuate the heat produced by the thermochemical reaction; otherwise, said reaction would be blocked before it is completed.

Furthermore, the reactive mixture composed of the reagent and the matrix binder will have a proportion by weight of reagent of between 85% and 96%, and preferably on the order of 94%.

In a variant of implementation of the invention, the gas to be stored is in liquid phase, and said liquid phase will undergo a vaporization step before it is introduced into the storage tank.

The gas can preferably be composed of ammonia, methylamine or hydrogen and the reagent can in particular be composed of alkaline salts, alkaline-earth salts, metal salts or a mixture thereof. Thus, in particular, manganese chloride, calcium chloride, barium chloride or a mixture thereof can be used.

An object of the present invention is also a device for storing a gas in solid phase for distribution in gaseous phase, characterized in that it comprises a storage tank containing a reactive mixture composed of expanded natural graphite and a reagent, the apparent density of which is between 40 kg/m³ and 60 kg/m³ and preferably on the order of 50 kg/m³, said reactive mixture and the gas being such that, when they are brought into the presence of one another, the reagent and the gas undergo a thermochemical reaction resulting in the absorption of the gas by the reagent and the production of a solid reaction product, and conversely, they undergo a desorption reaction of the gas absorbed by the reagent from the effect of heating applied thereto when it has absorbed the gas.

The present invention is particularly of interest in that the pressure in the storage tank is far less than the saturation vapor pressure of the gas to be stored, in other words, the pressure in a tank containing the same gas in liquefied form. Thus, it has been found that in a tank in which ammonia has been stored using a method according to the invention, the storage pressure at 45° C. is 7.3·10⁵ Pa, while in a tank containing liquid ammonia at the same temperature, the pressure is 18.2·10⁵ Pa.

It will be understood that under these conditions, the present invention makes it possible to greatly simplify the structure of storage tanks and decrease their wall thickness, resulting in particularly significant lowering of weights and costs.

Moreover, the volume of the quantity of gas stored is nearly independent of the storage temperature, which is particularly interesting when the storage tank of the gas is under conditions where the temperature is likely to vary considerably.

Furthermore, transport requires no special precautions or attention, which of course greatly facilitates it.

Finally, unlike tanks containing liquid gases in which the connectors must be distributed in very specific zones of the tank in order to prevent the gas in liquid phase from exiting, storage tanks according to the present invention may have connectors, the positioning of which will be totally free.

The present invention is of particular interest for applications where it is necessary to store a gas, in particular such as ammonia, in a restricted volume in containers of low weight and volume. Thus in the automobile industry, the present invention makes it possible to store in solid phase ammonia normally used in exhaust emission control, and to deliver it in gaseous phase as needed, simply by activating the reverse thermochemical reaction by the controlled heating of the reactor of the thermochemical system.

By way of non-limiting example, following is a description of a form of execution of the present invention, with reference to the appended drawing in which:

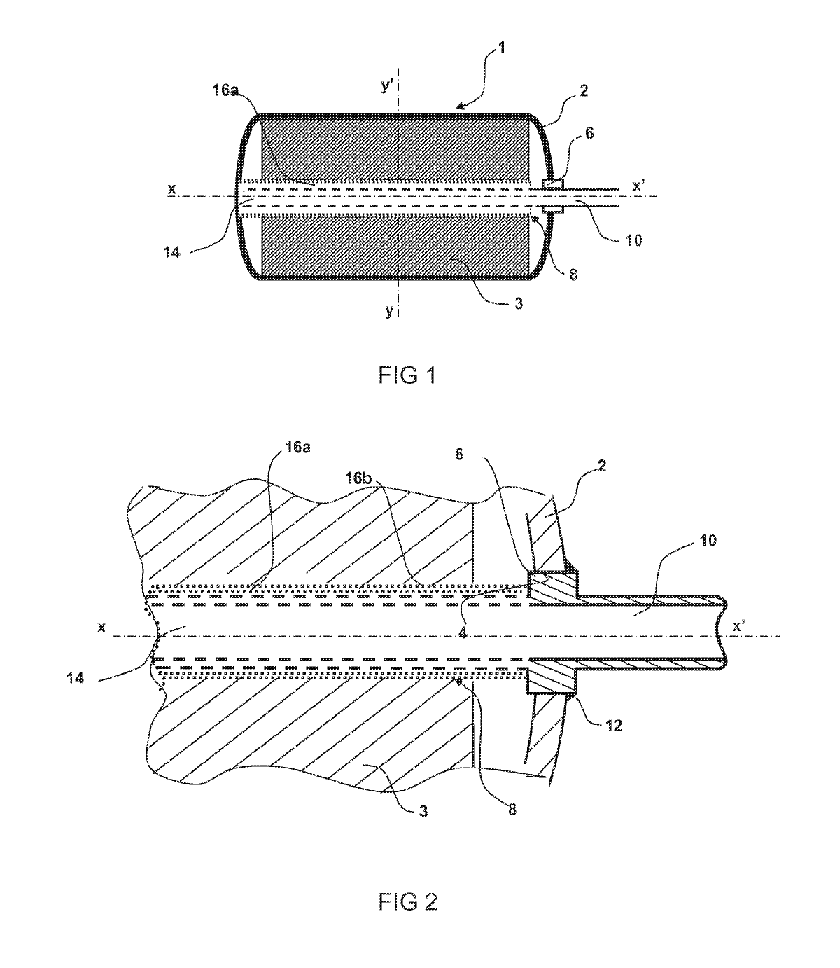

FIG. 1 is a schematic view in diametral and longitudinal cross-section of a storage tank according to the invention,

FIG. 2 is a schematic view in partial diametral and longitudinal cross-section of a variant of implementation of a storage tank according to the invention,

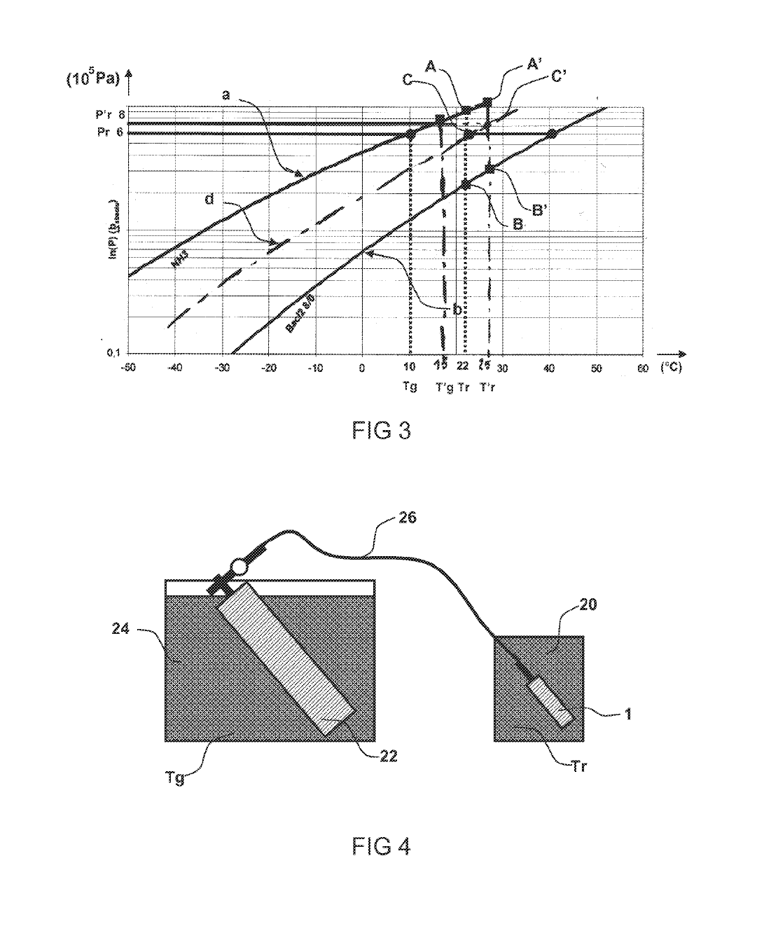

FIG. 3 is a pressure-temperature diagram representing the curves of the change of state of the ammonia and decomposition of the barium chloride used in a first filling mode of a storage tank,

FIG. 4 is a schematic representation of a filling facility,

FIG. 5 is a pressure-temperature diagram representing the curves of the change of state of the ammonia and decomposition of the barium chloride used in a second filling mode of a storage tank,

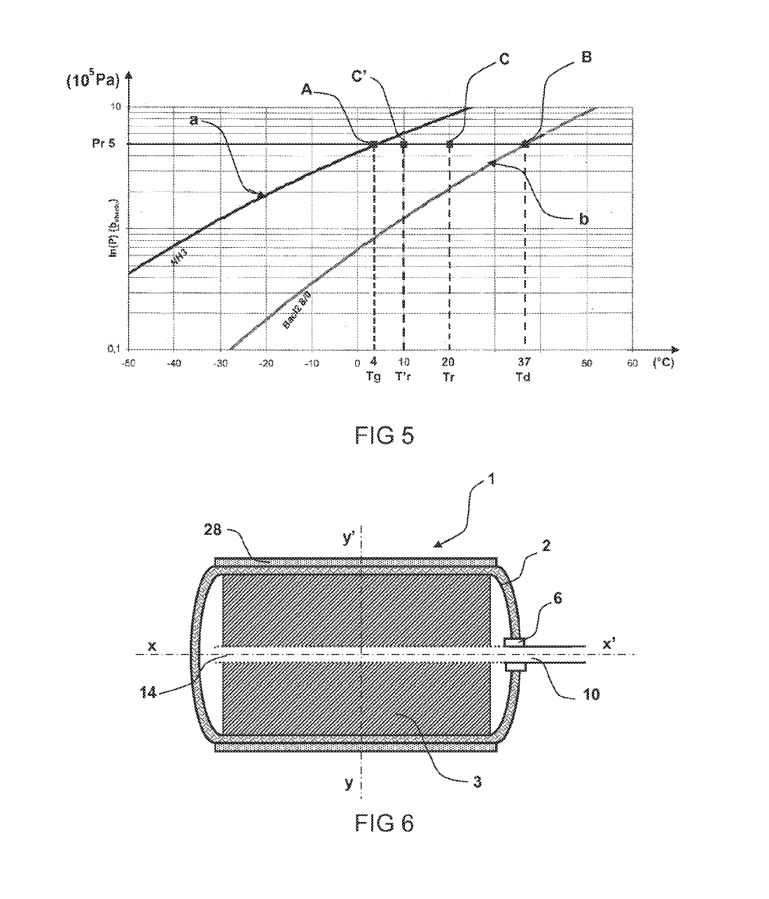

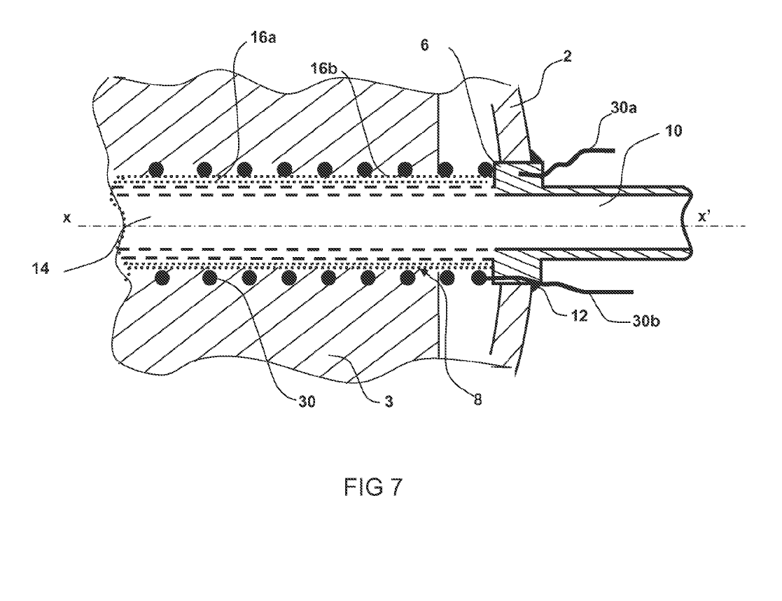

FIGS. 6 and 7 are schematic views in diametral and longitudinal cross-section of two variants of implementation of a storage tank according to the invention.

In the present example of implementation of the invention, ammonia gas is to be stored in a tank.

To accomplish this, a reagent—barium chloride in this instance—is first placed in this storage tank. Said reagent is able to react with the ammonia and to produce a solid reaction product according to the reaction:

BaCl₂+8(NH₃) [symbol] BaCl₂(NH₃)₈+δH_{R}

The reagent is first mixed with a “matrix binder” composed in this instance of expanded natural graphite (ENG), in order to constitute the reactive mixture.

Tests carried out by the applicant have resulted in finding that, to obtain a quantity of gas that is optimal with regard to the storage volume, the proportion of reagent in the reactive mixture should be far greater than what is used in cold production devices.

Thus, in these latter devices, the proportion T of reagent is on the order of 35% to 80%, that is, the reactive mixture contains by weight 35% to 80% reagent and 65% to 20% expanded natural graphite.

According to the invention, a reactive mixture is used in which the proportion by weight of reagent is between 85% and 96% and preferably on the order of 94%. The apparent density of the reactive mixture composed of expanded natural graphite and the reactive salt, i.e., the volume comprising the actual volume of the reactive mixture as well as the inter-grain spaces, will fall between 40 and 60 kg/m³ and preferably on the order of 50 kg/m³.

Under these conditions, a quantity of 600 g ammonia has been able to be stored in a volume of one liter of reactive mixture.

Represented schematically in FIGS. 1 and 2 is a storage tank 1 according to the invention, which is composed of an enclosure 2 inside which a reactive mixture 3, as defined previously, is disposed.

One of the ends of the storage tank 1 has an orifice 4 intended to receive a boss 6 of a diffuser 8. Said diffuser includes the gas intake/outlet pipe 10, which is connected to the means of utilization, and which is extended by the largest-diameter boss 6 intended to be placed in the orifice 4 and to provide for the attachment of the diffuser, for example by a weld 12 to the enclosure 2. The diffuser 8 is extended inside the storage tank 1, over the whole length of its enclosure 2, by a tubular part 14, which is perforated so that its porosity is between 10% and 90%.

A first function of the tubular part 14 is to promote a regular diffusion of the gas over the full length and into the mass of the reactive mixture 3. It has a second function, which is to ensure the diffusion of the gas in the reactive mixture along a radial path. It was found that the permeability of the reactive mixture 3 was optimal in that direction, insofar as that direction is perpendicular to the longitudinal direction of the compaction xx′.

The diffuser 8 is covered with a cylindrical sleeve 16a, particularly of stainless steel, the dimension of the mesh of which is preferably on the order of 10 μm. This unit may itself be slid into a second cylindrical sleeve 16b made of stainless steel mesh of greater porosity, thus the dimensions of the mesh are preferably on the order of 100 μm. The two sleeves 16a and 16b are supported against the boss 6 by one of their ends, and their other end is in contact with the bottom of the storage tank 1, so as to isolate the gas intake/outlet of the reactive mixture 3 and prevent the microparticles of said reactive mixture from plugging the control elements of the system.

Following is a description of a method for filling the storage tank 1. In particular, such a method makes it possible to fill the reactive mixture as quickly as possible with the gas to be stored without the gas at any time changing over to liquid phase, which would dissolve the reagent and therefore deteriorate it irreversibly.

Represented in FIG. 3 is a curve a that is representative of the change of state of the gas with which the storage tank 1 is to be filled, i.e., ammonia in this instance, and a curve b that is representative of the decomposition of the reagent composed of barium chloride in this instance, as a function of the temperature and pressure.

In this mode of implementation of the invention, a filling temperature Tr is chosen, equal for example to 22° C., and the segment AB between point A representing the saturation vapor pressure of the gas at that temperature and point B that represents the decomposition temperature of the barium chloride, at that same temperature, is taken into consideration. A point C called filling point is chosen on said segment AB. Based on the choice of said filling point, the filling can be optimally controlled in accordance with needs required by the chosen application.

Thus, the closer the filling point C is to the curve a, the faster the filling of the storage tank will be, but the risk increases of allowing drops of liquefied gas into it.

Therefore, if for a given application, the filling time of the storage tank 1 is not vital, but it is essential that not a drop of liquefied gas can penetrate the tank, then a filling point C is chosen, situated for example midway between points A and B, as represented in FIG. 3.

Under these conditions, it can be seen in FIG. 3 that for the filling temperature Tr of 22° C. and an operating point C midway between A and B, the pressure is 6·10⁵ Pa, which represents the filling pressure Pr. For ammonia, at said pressure Pr, the vaporization temperature is 10° C.

Under these conditions, according to the present invention, to fill the storage tank 1 with ammonia so that at no time during the course of the filling operation does liquefied gas penetrate into said tank, said tank is brought to and maintained at a filling temperature Tr of 22° C. and the container 2 containing the ammonia is brought to and maintained at a temperature Tg of 10° C., equal to its vaporization temperature at the filling pressure Pr.

To accomplish this, as represented in FIG. 4, for example the storage tank 1 to be filled is immersed in a vessel 20 containing a bath thermostatically controlled at the temperature Tr of 22° C. and the container 22 containing the ammonia is immersed in another vessel 24 containing a bath thermostatically controlled at the temperature Tg of 10° C., and the storage tank 1 and the container 22 are placed in communication by a conduit 26.

According to the invention, maintaining at temperature the storage tank 1 as well as the container 22 containing the ammonia can be accomplished with means other than thermostatically controlled baths, for example by heating or cooling collars.

Respective curves can be defined for which all of the filling points C are located in a specific position on the segment AB, and particularly in the middle thereof.

Represented in FIG. 3 is a curve d on which all of the filling points C are in the middle position.

A second filling point C′ is placed thereon, which corresponds to another filling temperature T′r, 25° C., and a filling pressure P′r of 8·10⁵ Pa is therefore obtained for which the vaporization temperature of the ammonia T′g is equal to 15° C. Under these conditions, during filling, the storage tank 1 will be maintained at a temperature T′r of 25° C. and the container 22 containing the ammonia at a temperature T′g of 15° C.

Thus, as mentioned before, and depending on the applications, the filling point C can be moved on the segment AB and the limits of this positioning can be such that AC and BC are ≧AB/10.

Under these conditions, Pr being the filling pressure of the storage tank 1, Pe being the equilibrium pressure of the reagent at the filling temperature Tr and Ps being the saturation vapor pressure of the gas at the filling temperature Tr:

Pr=Pe+α(Ps−Pe) where 0.1<α<0.9

In another mode of implementation of the present invention and as represented in FIG. 5, a filling pressure Pr is chosen, for example of 5·10⁵ Pa and the segment AB is considered between point A, representing the vaporization temperature Tg of the gas (4° C.) at that pressure, and point B representing the decomposition temperature Td of the reagent (37° C.) at that same pressure. A filling point C is chosen on said segment AB. Based on the position of point C on the segment AB, the filling will be able to be controlled optimally in accordance with the constraints specific to the chosen application, as in the preceding mode of implementation. Thus, AC and BC≧AB/10.

Under these conditions, Tr being the filling temperature of the storage tank 1, Tg being the vaporization temperature of the gas at the filling pressure Pr, Te being the equilibrium temperature of the reagent at the filling pressure Pr:

Tr=Tg+β(Td−Tg) where 0.1<β<0.9

Thus, if for a given application, the filling time of the storage tank 1 is not vital, but it is essential that not a drop of the liquefied gas penetrate into said tank, a filling point C will be chosen that is situated, for example, midway between the points A and B. Under these conditions, for a filling pressure Pr of 5·10⁵ Pa, the filling temperature Tr at which the storage tank 1 will be maintained during the filling operation will be 20° C. and the temperature Tg, at which the container 22 containing the gas will be maintained, will therefore be 4° C.

However, if for another application the filling time is vital, then an operation point C′ closer to point A will be chosen, with the risk of allowing a few drops of liquefied gas into the storage tank 1, obviously to the detriment of the working life of the reagent. Under these conditions, the temperature T′r, at which the storage tank 1 will be maintained during filling, will then be 10° C.

The gas stored in the tank 1 is therefore available to be used in any appropriate application.

When all or part of the gas stored in the tank 1 is to be recovered, the reverse thermochemical reaction is activated by heating the solid reaction product:

Mn(NH₃)₆Cl₂+δH_{R}<->Mn(NH₃)₂Cl₂+₄(NH₃)

Said heating may be accomplished for example by an electric heating sleeve 28, which will be disposed around the tank 1, as represented in FIG. 6.

The heating can also be provided by means that are integrated into the diffuser. Thus, as shown in FIG. 7, a heating wire 30, preferably of stainless steel, can be wound around the outer sleeve 16b of the diffuser and its power supply wires 30a and 30b pass through the boss 6 to go to an external power source not shown in the drawing.

In a variant of implementation of the present invention, the storage tank 1 is provided with means for verifying that it is completely emptied during the reverse thermochemical reaction.

1. Method of storing a gas in solid phase for distribution in gaseous phase, comprising introducing the gas in gaseous phase into a storage tank (1) containing a reactive mixture, the apparent density of which is between 40 kg/m3 and 60 kg/m3 and preferably on the order of 50 kg/m3, and which is composed of a reagent and expanded natural graphite, said reactive mixture and the gas being such that, when brought into the presence of one another, the reagent and the gas undergo a thermochemical reaction, the effect of which is that the gas is absorbed by the reagent and a solid reaction product is produced and, conversely, they undergo a reverse thermochemical reaction in which the gas absorbed by the reagent is desorbed when this product is heated after it has absorbed the gas.

2. Storage method according to claim 1, characterized in that a reactive mixture (3) is used, of which the proportion by weight of reagent in the reactive mixture is between 85% and 96% and is preferably on the order of 94%.

3. Storage method according to claim 1, wherein the gas to be stored is in liquid phase, characterized in that said liquefied gas undergoes a vaporization step prior to its introduction into the storage tank.

4. Device for storage of a gas in solid phase for distribution in gaseous phase, characterized in that it comprises a storage tank containing a reactive mixture composed of expanded natural graphite and a reagent, the apparent density of which is between 40 kg/m3 and 60 kg/m3 and preferably on the order of 50 kg/m3, said reactive mixture and the gas being such that, when they are brought into the presence of one another, the reagent and the gas undergo a thermochemical reaction resulting in the absorption of the gas by the reagent and the production of a solid reaction product, and conversely, they undergo a desorption reaction of the gas absorbed by the reagent from the effect of heating applied thereto when it has absorbed the gas.

5. Storage device according to claim 4, characterized in that the proportion by weight of reagent in the reactive mixture is between 85% and 96%, and preferably on the order of 94%.

6. Storage device according to claim 4, characterized in that the reactive mixture is in the form of a block.

7. Storage device according to claim 4, characterized in that the gas is ammonia, and/or methylamine and/or hydrogen.

8. Storage device according to claim 4, characterized in that the reagent in particular is composed of alkaline salts, and/or alkaline-earth salts, and/or metal salts.

9. Storage device according to claim 8, characterized in that the reagent is composed of manganese chloride and/or barium chloride and/or calcium chloride.
